(19) United States
(12) Patent Application Publication
(10) Pub. No.: US 2016/0201889 A1
(43) Pub. Date: Jul. 14, 2016

(54) ILLUMINATION DEVICE AND LIGHT-EMITTING MODULE THEREOF

(71) Applicant: LUSTROUS TECHNOLOGY LTD., NEW TAIPEI CITY (TW)

(72) Inventors: DAWSON LIU, TAIPEI CITY (TW); CHIA-LUNG HSUEH, YILAN COUNTY (TW); KAO-HSU CHOU, TAIPEI CITY (TW)

(21) Appl. No.: 14/592,972

(22) Filed: Jan. 9, 2015

(51) Int. Cl. F21V 23/06; F21V 29/70; F21V 1/00

(52) U.S. Cl. CPC F21V 23/06; F21V 1/00; F21V 29/70; F21Y 2101/02

(57) ABSTRACT

An illumination device includes a light-emitting module and a lampshade module. The light-emitting module includes a heat-dissipating body, a carrier substrate disposed on the heat-dissipating body, a light-emitting unit disposed on the carrier substrate, and a circuit substrate disposed on the carrier substrate and electrically connected with the carrier substrate to surround the light-emitting unit. The circuit substrate and the heat-dissipating body are separated from each other by a predetermined distance. The lampshade module includes a casing structure disposed on the heat-dissipating body and the circuit substrate and a lampshade structure detachably disposed on the casing structure. The casing structure has at least two first retaining portions, and the lampshade structure has at least two second retaining portions. The lampshade structure is detachably positioned on the casing structure by matching the at least two first retaining portions and the at least two second retaining portions.

### BACKGROUND OF THE INVENTION

1. Field of the Invention

The instant disclosure relates to an illumination device and a light-emitting module thereof, and more particularly to an illumination device and a light-emitting module thereof including a circuit substrate for carrying electronic components and a carrier substrate for carrying a light-emitting unit, and the circuit substrate disposed on the carrier substrate and electrically connected to the carrier substrate.

2. Description of Related Art

LEDs are now widely used as illuminators, indicators or displays in many kinds of electronic products or industrial applications. One of the advantages of LEDs is that they consume much less electricity, or energy, as comparing with other traditional lighting devices. This is because the LEDs are known as solid state devices that generate light through a luminescence process. Thus, the light generated by LEDs is referred to “cold light”. Besides, another advantage of LEDs is its small size. An LED is provided as a semiconductor chip. Hence, LEDs can meet the size-reducing requirement of modern electronic products, especially the delicate electronic products.

### SUMMARY OF THE INVENTION

One aspect of the instant disclosure relates to an illumination device and a light-emitting module thereof including a circuit substrate for carrying electronic components and a carrier substrate for carrying a light-emitting unit, and the circuit substrate is disposed on the carrier substrate and electrically connected to the carrier substrate.

One of the embodiments of the instant disclosure provides an illumination device, comprising: a light-emitting module and a lampshade module. The light-emitting module includes a heat-dissipating body, a carrier substrate disposed on the heat-dissipating body, a light-emitting unit disposed on the carrier substrate and electrically connected to the carrier substrate, and a circuit substrate disposed on the carrier substrate to surround the light-emitting unit, wherein the circuit substrate is electrically connected with the carrier substrate, and the circuit substrate and the heat-dissipating body are separated from each other by a predetermined distance. The lampshade module includes a casing structure disposed on the heat-dissipating body and the circuit substrate and a lampshade structure detachably disposed on the casing structure. More precisely, the casing structure has a receiving groove concaved downwardly from a top side thereof, and the casing structure has a surrounding carrier surface disposed inside the receiving groove and a through opening communicated with the receiving groove for exposing the light-emitting unit. More precisely, the casing structure has at least two first retaining portions disposed on the surrounding carrier surface, the lampshade structure has at least two second retaining portions respectively corresponding to the at least two first retaining portions, and the lampshade structure is detachably positioned on the surrounding carrier surface of the casing structure by matching the at least two first retaining portions and the at least two second retaining portions.

Another one of the embodiments of the instant disclosure provides a light-emitting module, comprising: a heat-dissipating body, a carrier substrate, a light-emitting unit, and a circuit substrate. The carrier substrate is disposed on the heat-dissipating body. The light-emitting unit is disposed on the carrier substrate and electrically connected to the carrier substrate. The circuit substrate is disposed on the carrier substrate to surround the light-emitting unit, wherein the circuit substrate is electrically connected with the carrier substrate, and the circuit substrate and the heat-dissipating body are separated from each other by a predetermined distance.

Therefore, the circuit substrate for carrying the electronic components can be disposed on the carrier substrate for carrying the light-emitting unit and electrically connected to the carrier substrate for carrying the light-emitting unit due to the designs of “the carrier substrate disposed on the heat-dissipating body, and the light-emitting unit disposed on the carrier substrate and electrically connected to the carrier substrate” and “the circuit substrate disposed on the carrier substrate and electrically connected with the carrier substrate to surround the light-emitting unit, and the circuit substrate and the heat-dissipating body are separated from each other by a predetermined distance”.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a partial, perspective, assembled, schematic view of the illumination device according to the instant disclosure;

FIG. 2 shows a perspective, exploded, schematic view of the illumination device according to the instant disclosure;

FIG. 3 shows another perspective, exploded, schematic view of the illumination device according to the instant disclosure;

FIG. 4 shows a lateral, cross-sectional, schematic view of the light-emitting module of the illumination device according to the instant disclosure;

FIG. 5 shows a top, schematic view of the casing structure of the illumination device according to the instant disclosure;

FIG. 6 shows a bottom, schematic view showing the relationship between the first retaining portion and the second retaining portion before retaining the first retaining portion with the second retaining portion according to the instant disclosure; and

FIG. 7 shows a bottom, schematic view showing the relationship between the first retaining portion and the second retaining portion after retaining the first retaining portion with the second retaining portion according to the instant disclosure.

### DETAILED DESCRIPTION OF THE PREFERRED EMBODIMENTS

The embodiments of “an illumination device and a light-emitting module thereof” of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

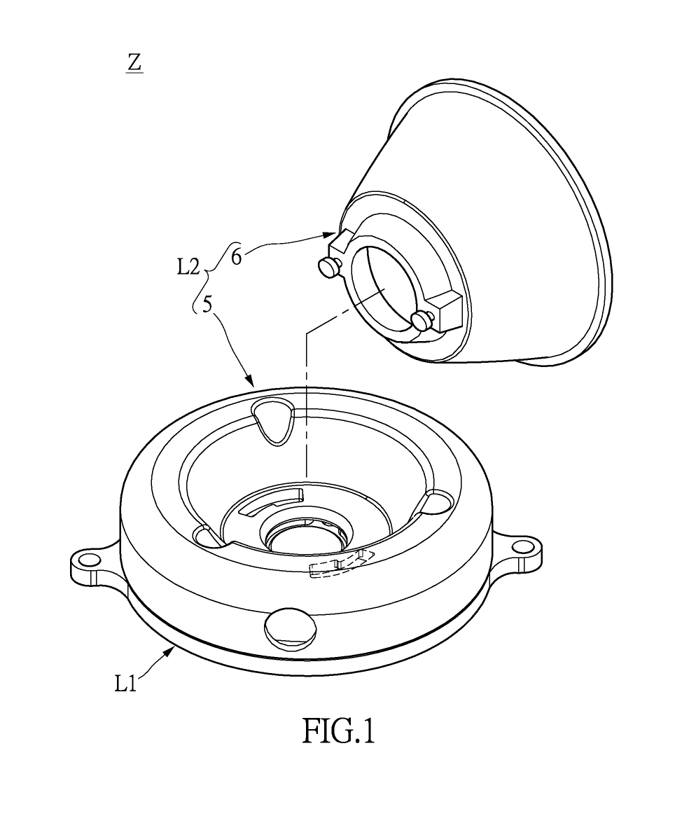

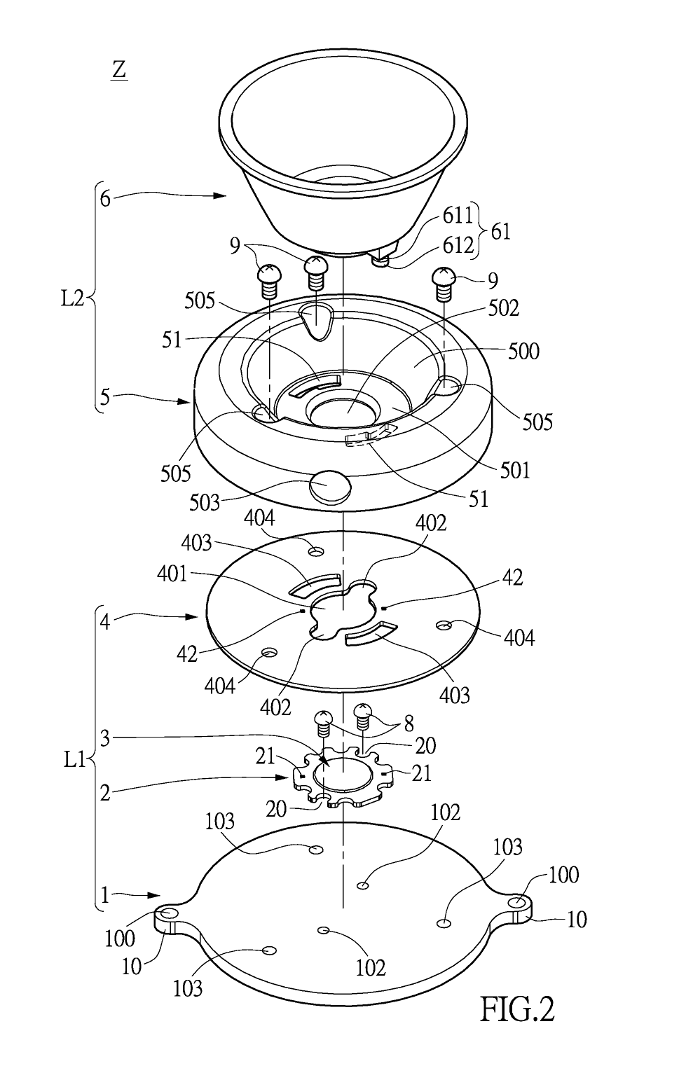

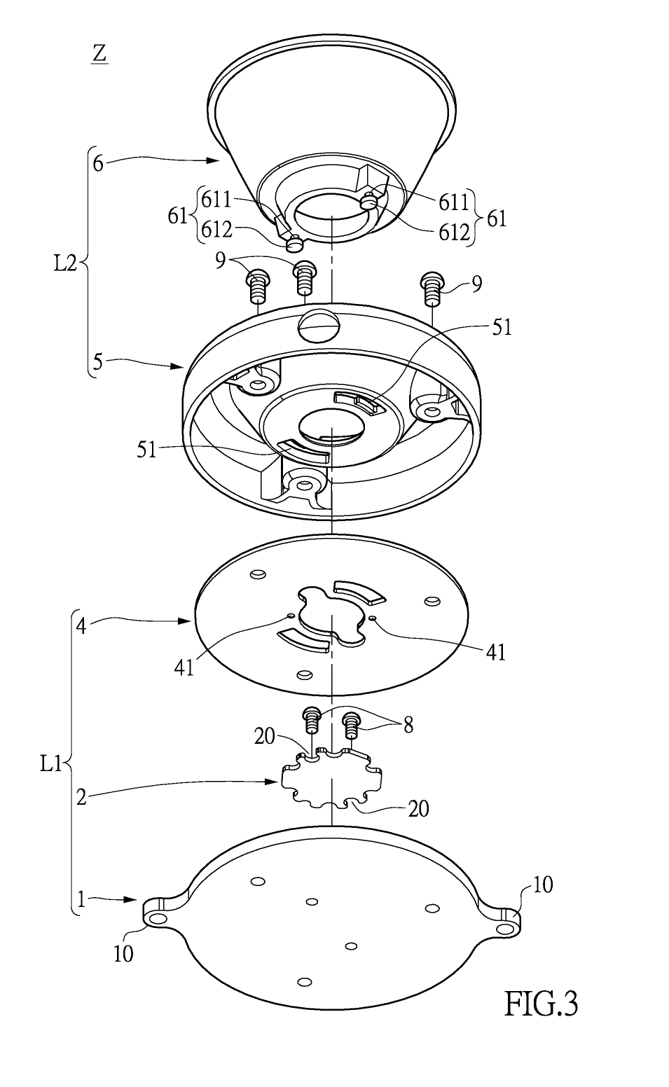

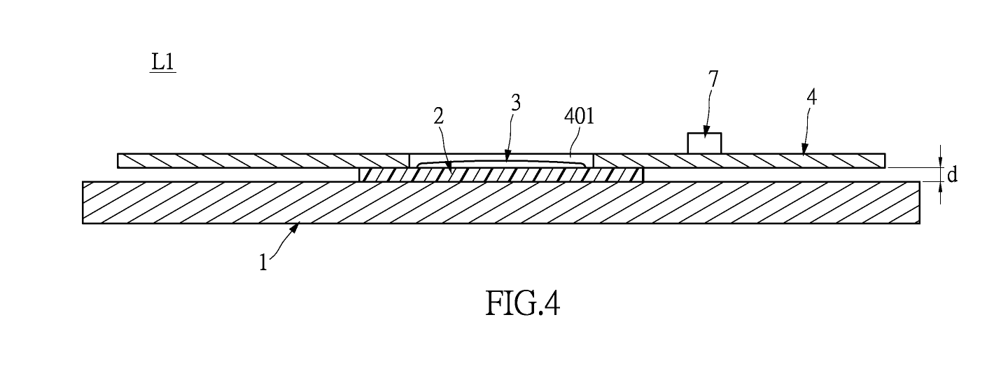

Referring to FIG. 1 to FIG. 4, in which FIG. 1 shows a partial, perspective, assembled, schematic view of the illumination device according to the instant disclosure, FIG. 2 shows a perspective, exploded, schematic view of the illumination device according to the instant disclosure, FIG. 3 shows another perspective, exploded, schematic view of the illumination device according to the instant disclosure, and FIG. 4 shows a lateral, cross-sectional, schematic view of the light-emitting module of the illumination device according to the instant disclosure. The instant disclosure provides an illumination device Z comprising a light-emitting module L1 and a lampshade module L2.

First, referring to FIG. 1, FIG. 2, and FIG. 4, the light-emitting module L1 includes a heat-dissipating body 1, a carrier (carrying) substrate 2 disposed on the heat-dissipating body 1, a light-emitting unit 3 disposed on the carrier substrate 2 and electrically connected to the carrier substrate 2, and a circuit substrate 4 disposed on the carrier substrate 2 to surround the light-emitting unit 3. In addition, the circuit substrate 4 is electrically connected with the carrier substrate 2, and the circuit substrate 4 and the heat-dissipating body 1 are separated from each other by a predetermined distance d. It is worth noting that the circuit substrate 4 is supported by the carrier substrate 2 as shown in FIG. 4, so that the circuit substrate 4 is separated from the heat-dissipating body 1 by a predetermined distance d without contacting the heat-dissipating body 1. For example, the light-emitting unit 3 includes a plurality of LED chips disposed on the carrier substrate 2 and a package resin body disposed on the carrier substrate 2 to enclose the LED chips, but this is merely an example and is not meant to limit the instant disclosure.

Moreover, referring to FIG. 1 and FIG. 2, the lampshade module 2 includes a casing (housing) structure 5 disposed on the heat-dissipating body 1 and the circuit substrate 4 and a lampshade structure 6 (such as a reflector) detachably disposed on the casing structure 5. In addition, the casing structure 5 has a receiving groove 500 (or a receiving space) concaved downwardly from a top side thereof, and the casing structure 5 has a surrounding carrier surface 501 disposed inside the receiving groove 500 and a through opening 502 communicated with the receiving groove 500 for exposing the light-emitting unit 3. Furthermore, the casing structure 5 has at least two first retaining portions 51 disposed on the surrounding carrier surface 501, the lampshade structure 6 has at least two second retaining portions 61 respectively corresponding to the at least two first retaining portions 51. Therefore, the lampshade structure 6 is detachably positioned on the surrounding carrier surface 501 of the casing structure 5 by matching the at least two first retaining portions 51 and the at least two second retaining portions 61 (such as retaining the at least two first retaining portions 51 with the at least two second retaining portions 61).

More precisely, referring to FIG. 1, FIG. 2, and FIG. 3, the heat-dissipating body 1 has two convex rib portions 10 respectively extended from two opposite sides thereof, and each of the convex rib portions 10 has a first fixing hole 100 passing therethrough. In addition, the heat-dissipating body 1 has two second fixing holes 102 and a plurality of third fixing holes 103, and the carrier substrate 2 has two fixing grooves 20 respectively corresponding to the two second fixing holes 102. Moreover, the carrier substrate 2 is fixed on the heat-dissipating body 1 through two first fixing members 8 (such as screw bolts), and each of the first fixing members 8 sequentially passes through the corresponding fixing groove 20 and the corresponding second fixing hole 102. In other words, each first fixing member 8 sequentially passes through the corresponding fixing groove 20 and the corresponding second fixing hole 102 in order to fix the carrier substrate 2 on the heat-dissipating body 1.

More precisely, referring to FIG. 2, FIG. 3, and FIG. 4, the circuit substrate 4 has a first opening 401 for exposing the light-emitting unit 3, two second openings 402 communicated with the first opening 401 for respectively exposing the two first fixing members 8, and at least two third openings 403 respectively corresponding to the at least two first retaining portions 51, and the circuit substrate 4 has a plurality of fourth fixing holes 404 respectively corresponding to the third fixing holes 103.

More precisely, referring to FIG. 2, FIG. 3, and FIG. 4, the carrier substrate 2 has at least two first conductive pads 21 (such as a contact point) disposed on a top surface thereof. The circuit substrate 4 has at least two second conductive pads 41 respectively electrically contacting the at least two first conductive pads 21 (as shown in FIG. 3), and the circuit substrate 4 has at least two conductive connection portions 42 passing therethrough and respectively electrically contacting the at least two second conductive pads 41 (as shown in FIG. 2). In addition, the light-emitting module L1 includes a plurality of electronic components 7 (such as driving components or passive components) disposed on the circuit substrate 4 and electrically connected to conductive traces (not shown) of the circuit substrate 4, and the electronic components 7 are electrically connected to the light-emitting unit 3 through the conductive connection portion 42 electrically connected to the conductive traces, the second conductive pad 41, and the first conductive pad 21 in sequence.

More precisely, referring to FIG. 1, FIG. 2, and FIG. 3, the casing structure 5 has a plurality of fifth fixing holes 505 respectively corresponding to the fourth fixing holes 404. In addition, the casing structure 5 is fixed on the heat-dissipating body 1 through a plurality of second fixing members 9 (such as screw bolts), and each of the second fixing members 9 sequentially passes through the corresponding fifth fixing hole 505, the corresponding fourth fixing hole 404, and the corresponding third fixing hole 103. In other words, each second fixing member 9 sequentially passes through the corresponding fifth fixing hole 505, the corresponding fourth fixing hole 404, and the corresponding third fixing hole 103 in order to fix the casing structure 5 on the heat-dissipating body 1. It is worth noting that the casing structure 5 further has a power line hole 503 for guiding a DC power line (not shown) that is electrically connected to the circuit substrate 4.

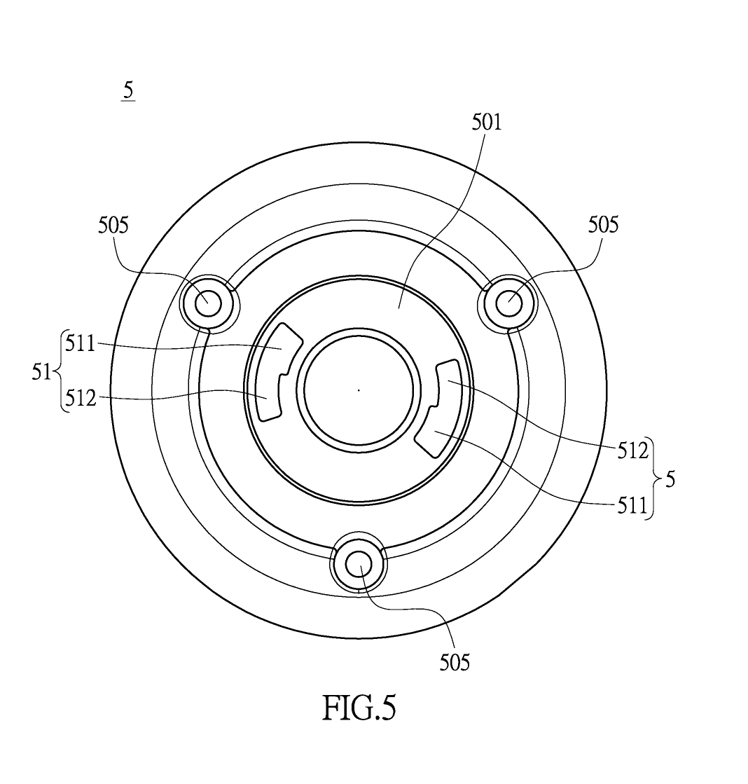

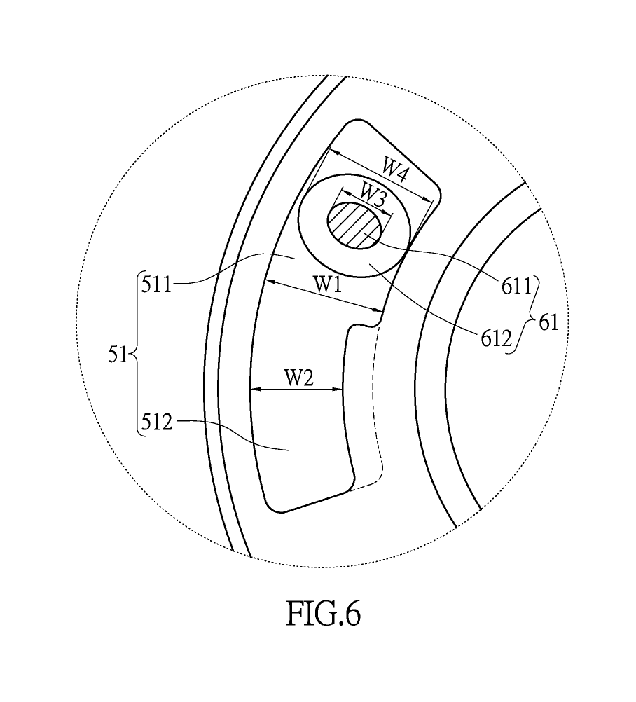

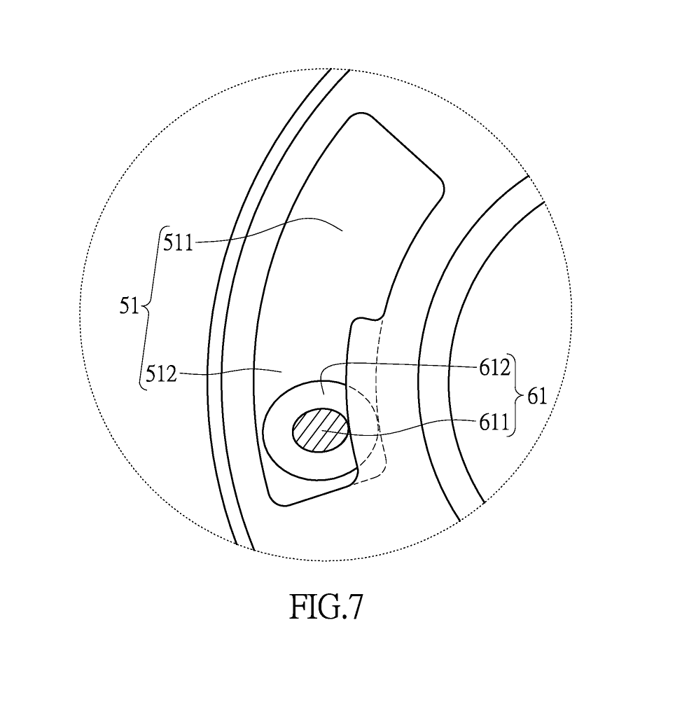

Referring to FIG. 5 to FIG. 7, in which FIG. 5 shows a top, schematic view of the casing structure of the illumination device according to the instant disclosure, FIG. 6 shows a bottom, schematic view showing the relationship between the first retaining portion and the second retaining portion before retaining the first retaining portion with the second retaining portion according to the instant disclosure, and FIG. 7 shows a bottom, schematic view showing the relationship between the first retaining portion and the second retaining portion after retaining the first retaining portion with the second retaining portion according to the instant disclosure.

First, referring to FIG. 5 and FIG. 6, each of the first retaining portions 51 has a first guiding opening 511 passing through the casing structure 5 and a second guiding opening 512 passing through the casing structure 5 and communicated with the first guiding opening 511, and the width W1 of the first guiding opening 511 is larger than the width W2 of the second guiding opening 512.

Furthermore, referring to FIG. 2 and FIG. 7, each of the second retaining portions 61 has a first retaining body 611 extended downwardly from a bottom side of the lampshade structure 6 and movably disposed inside the second guiding opening 512 (or disposed inside the upper half of the second guiding opening 512) and a second retaining body 612 extended downwardly from the first retaining body 611 and movably disposed under the second guiding opening 512 (or disposed inside the lower half of the second guiding opening 512). As shown in FIG. 6, the width W3 of the first retaining body 611 is smaller the width W4 of the second retaining body 612.

It is worth noting that the width W4 of the second retaining body 612 is smaller than the width W1 of the first guiding opening 511, so that each second retaining portion 61 can be directly inserted into the first guiding opening 511 of the corresponding first retaining portion 51. In addition, the width W4 of the second retaining body 612 is larger than the width W2 of the second guiding opening 512, so that when the second retaining portion 61 is moved from the first guiding opening 511 (as shown in FIG. 6) to the second guiding opening 512 (as shown in FIG. 7), the second retaining body 612 of the second retaining portion 61 is retained under the second guiding opening 512, especially the first retaining body 611 is inwardly abutted against the inner surface of the lower half of the second guiding opening 512 or further the second retaining body 612 is inwardly abutted against the inner surface (shown as the dotted line in FIG. 7) of the lower half of the second guiding opening 512. Therefore, the lampshade structure 6 can be detachably positioned on the surrounding carrier surface 501 of the casing structure 5 by matching the at least two first retaining portions 51 and the at least two second retaining portions 61.

Therefore, the circuit substrate 4 for carrying the electronic components 7 can be disposed on the carrier substrate 2 for carrying the light-emitting unit 3 and electrically connected to the carrier substrate 2 for carrying the light-emitting unit 3 due to the designs of “the carrier substrate 2 disposed on the heat-dissipating body 1, and the light-emitting unit 3 disposed on the carrier substrate 2 and electrically connected to the carrier substrate 2” and “the circuit substrate 4 disposed on the carrier substrate 2 and electrically connected with the carrier substrate 2 to surround the light-emitting unit 3, and the circuit substrate 4 and the heat-dissipating body 1 are separated from each other by a predetermined distance d”.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. An illumination device, comprising:
a light-emitting module including a heat-dissipating body, a carrier substrate disposed on the heat-dissipating body, a light-emitting unit disposed on the carrier substrate and electrically connected to the carrier substrate, and a circuit substrate disposed on the carrier substrate to surround the light-emitting unit, wherein the circuit substrate is electrically connected with the carrier substrate, and the circuit substrate and the heat-dissipating body are separated from each other by a predetermined distance; and
a lampshade module including a casing structure disposed on the heat-dissipating body and the circuit substrate and a lampshade structure detachably disposed on the casing structure;
wherein the casing structure has a receiving groove concaved downwardly from a top side thereof, and the casing structure has a surrounding carrier surface disposed inside the receiving groove and a through opening communicated with the receiving groove for exposing the light-emitting unit;
wherein the casing structure has at least two first retaining portions disposed on the surrounding carrier surface, the lampshade structure has at least two second retaining portions respectively corresponding to the at least two first retaining portions, and the lampshade structure is detachably positioned on the surrounding carrier surface of the casing structure by matching the at least two first retaining portions and the at least two second retaining portions.

2. The illumination device of claim 1, wherein the carrier substrate has at least two first conductive pads disposed on a top surface thereof, the circuit substrate has at least two second conductive pads respectively electrically contacting the at least two first conductive pads, and the circuit substrate has at least two conductive connection portions passing therethrough and respectively electrically contacting the at least two second conductive pads, wherein the light-emitting module includes a plurality of electronic components disposed on the circuit substrate and electrically connected to the circuit substrate, and the electronic components are electrically connected to the light-emitting unit through the conductive connection portion, the second conductive pad, and the first conductive pad in sequence.

3. The illumination device of claim 1, wherein the heat-dissipating body has two convex rib portions respectively extended from two opposite sides thereof, and each of the convex rib portions has a first fixing hole passing therethrough, wherein the heat-dissipating body has two second fixing holes and a plurality of third fixing holes, and the carrier substrate has two fixing grooves respectively corresponding to the two second fixing holes, wherein the carrier substrate is fixed on the heat-dissipating body through two first fixing members, and each of the first fixing members sequentially passes through the corresponding fixing groove and the corresponding second fixing hole.

4. The illumination device of claim 3, wherein the circuit substrate has a first opening for exposing the light-emitting unit, two second openings communicated with the first opening for respectively exposing the two first fixing members, and at least two third openings respectively corresponding to the at least two first retaining portions, and the circuit substrate has a plurality of fourth fixing holes respectively corresponding to the third fixing holes.

5. The illumination device of claim 3, wherein the casing structure has a plurality of fifth fixing holes respectively corresponding to the fourth fixing holes, the casing structure is fixed on the heat-dissipating body through a plurality of second fixing members, and each of the second fixing members sequentially passes through the corresponding fifth fixing hole, the corresponding fourth fixing hole, and the corresponding third fixing hole, wherein each of the first retaining portions has a first guiding opening passing through the casing structure and a second guiding opening passing through the casing structure and communicated with the first guiding opening, and the width of the first guiding opening is larger than the width of the second guiding opening.

6. The illumination device of claim 5, wherein each of the second retaining portions has a first retaining body extended downwardly from a bottom side of the lampshade structure and movably disposed inside the second guiding opening and a second retaining body extended downwardly from the first retaining body and movably disposed under the second guiding opening, and the width of the first retaining body is smaller the width of the second retaining body, wherein the width of the second retaining body is smaller than the width of the first guiding opening, and the width of the second retaining body is larger than the width of the second guiding opening.

7. A light-emitting module, comprising:
a heat-dissipating body;
a carrier substrate disposed on the heat-dissipating body;
a light-emitting unit disposed on the carrier substrate and electrically connected to the carrier substrate; and
a circuit substrate disposed on the carrier substrate to surround the light-emitting unit, wherein the circuit substrate is electrically connected with the carrier substrate, and the circuit substrate and the heat-dissipating body are separated from each other by a predetermined distance.

8. The light-emitting module of claim 7, wherein the carrier substrate has at least two first conductive pads disposed on a top surface thereof, the circuit substrate has at least two second conductive pads respectively electrically contacting the at least two first conductive pads, and the circuit substrate has at least two conductive connection portions passing therethrough and respectively electrically contacting the at least two second conductive pads, wherein the light-emitting module includes a plurality of electronic components disposed on the circuit substrate and electrically connected to the circuit substrate, and the electronic components are electrically connected to the light-emitting unit through the conductive connection portion, the second conductive pad, and the first conductive pad in sequence.

9. The light-emitting module of claim 7, wherein the heat-dissipating body has two convex rib portions respectively extended from two opposite sides thereof, and each of the convex rib portions has a first fixing hole passing therethrough, wherein the heat-dissipating body has two second fixing holes and a plurality of third fixing holes, and the carrier substrate has two fixing grooves respectively corresponding to the two second fixing holes, wherein the carrier substrate is fixed on the heat-dissipating body through two first fixing members, and each of the first fixing members sequentially passes through the corresponding fixing groove and the corresponding second fixing hole.

10. The light-emitting module of claim 9, wherein the circuit substrate has a first opening for exposing the light-emitting unit, two second openings communicated with the first opening for respectively exposing the two first fixing members, and at least two third openings respectively corresponding to the at least two first retaining portions, and the circuit substrate has a plurality of fourth fixing holes respectively corresponding to the third fixing holes.
